(19) United States
(12) Patent Application Publication
(10) Pub. No.: US 2017/0194679 A1
(43) Pub. Date: Jul. 6, 2017

(54) Composite Heat Exchanger for Batteries and Method of Making Same

(71) Applicant: GM Global Technology Operations LLC, Detroit, MI (US)

(72) Inventors: Debejyo Chakraborty, Novi, MI (US); Michael P. Balogh, Novi, MI (US); James R. Salvador, Royal Oak, MI (US); Teresa J. Rinker, Royal Oak, MI (US); Leonid C. Lev, West Bloomfield, MI (US)

(73) Assignee: GM Global Technology Operations LLC, Detroit, MI (US)

(21) Appl. No.: 14/984,384

(22) Filed: Dec. 30, 2015

(51) Int. Cl. H01M 10/6556; H01M 10/613; H01M 10/625; B23P 15/26

(52) U.S. Cl. CPC H01M 10/6556; B23P 15/26; H01M 10/613; H01M 10/625; H01M 2220/20

(57) ABSTRACT

A heat exchanger and a method of making same that includes a central polymer core plate laminated on each side with a composite skin. The composite skin includes an electrically insulating outer layer, a middle metal layer to improve thermal conductivity and reduce diffusivity, and an inner layer that will thermally bond to the polymer core plate. A roll to roll method of making the heat exchanger is provided.

### FIELD OF THE INVENTION

The present technology relates to a heat exchanger for regulating the temperature of one or more battery cells, and a method for making a heat exchanger. The heat exchanger includes a central polymer core plate laminated on each side with a skin.

### BACKGROUND OF THE INVENTION

This section provides background information related to the present disclosure which is not necessarily prior art.

Unwanted heat is often generated in automobile batteries, from exothermic discharging reactions, Joule heating during charging and discharging associated with the internal resistance of the cells, and ambient heat in hot weather. In addition, it is sometimes desirable to apply heat to automobile batteries, such as in very cold weather conditions. Although the following description is directed specifically to the removal of heat from automobile batteries the technology is also applicable to the application of heat to automobile batteries. It is also applicable to heat exchangers useful for other purposes.

It is important to prevent the temperature of an automobile battery from exceeding a safe operating range. External cooling is required to restrict the temperature from exceeding a specified temperature threshold such that the battery health, longevity, and passenger safety are not compromised. Commonly, the battery cell temperature is restricted to about 55° C.

The removal of heat in power batteries, like the ones used in extended range electric vehicles (EREV) and battery electric vehicles (BEV), is achieved by active liquid cooling. Some energy batteries, like the ones used in hybrid cars, are typically air cooled. The type of cooling is chosen by the amount of heat that needs to be rejected per unit time. Power batteries generate significantly more heat and thus need to be cooled more rapidly.

Liquid cooling is implemented by running coolant through heat exchangers, also referred to as cooling fins and cooling plates, which are embedded in the battery packs. FIG. 1 shows an example of a heat exchanger 10 used in an EREV battery. Coolant, which may be a mix of 50% DEX-COOL® and 50% deionized water, for example, enters through the inlet openings 12 at the lower left, travels through the channels 14, and exits through the outlet openings 16 at the lower right. Placement of the inlets and outlets is a variable feature. As shown in FIG. 2, the prior art heat exchanger 10 is made of two aluminum half plates 20, 22 that are brazed together to form the heat exchanger 10. The plates are laminated with polyethylene terephthalate or another polymer to obtain electrical insulation.

The method of making this prior art heat exchanger requires two expensive processes, brazing and lamination (which must be done in a clean room).

Accordingly, what is needed is a heat exchanger that is relatively inexpensive to produce, that includes a rigid core structure in which coolant channels can be patterned, a highly thermally conductive outer layer that will facilitate heat transfer from the battery to the coolant, and assurance of electrical isolation between any metal that is used and the battery.

### SUMMARY OF THE INVENTION

The present technology includes a heat exchanger and a method of making same.

In some embodiments, a heat exchanger is provided that includes a central polymer core plate laminated on each side with a skin. The core plate has a first surface, a second surface, and a cutout, where the cutout includes an inlet, an outlet, and a flow field between the inlet and the outlet. A first skin is coupled to the first surface and a second skin is coupled to the second surface. The flow field, the first skin, and the second skin form at least one conduit that fluidly connects the inlet and the outlet.

The core plate is made of a polymer. The skin is a composite, preferably a trilayer that includes an electrically insulating outer layer, a middle layer to improve thermal conductivity and reduce diffusivity, and an inner layer that will nonadhesively bond to the polymer core plate.

In a preferred embodiment, the core plate surfaces are textured to improve the lamination adhesion of the skins.

In certain embodiments, a roll to roll method of making a heat exchanger is provided that includes using a laminator to attach the skins to a roll of core material. An inline cutter is used to form the channels in the core plate as the skins are laminated. The inline cutter is preferably a laser cutter.

In a preferred embodiment, the method includes double hemming the cut edges of the skin to prevent exposure of the metal layer.

In various embodiments, a method of cooling a battery cell is provided that includes placing at least one heat exchanger according to the present technology in thermal contact with the battery cell. A cooling fluid is circulated through at least one conduit of the heat exchanger.

Other aspects and features of the present invention will be in part apparent and in part pointed out hereinafter.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a perspective view of an embodiment of a heat exchanger according to the prior art.

FIG. 2 is a perspective cutaway view of a heat exchanger according to the prior art.

FIG. 3 depicts a heat exchanger according to the present technology.

FIG. 4 depicts a heat exchanger core plate of an embodiment of the present technology.

FIG. 5 depicts a cutaway view of a heat exchanger of an embodiment of the present technology.

FIG. 6 depicts an embodiment of a method of making a heat exchanger according to the present technology.

### DETAILED DESCRIPTION OF EXEMPLARY EMBODIMENTS OF THE INVENTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding the methods disclosed, the order of the steps presented is exemplary in nature, and thus, the order of the steps can be different in various embodiments where possible. Except where otherwise expressly indicated, all numerical quantities in this description are to be understood as modified by the word “about” in describing the broadest scope of the technology.

The present technology relates to a heat exchanger for a battery cell or a battery cell assembly. The heat exchanger includes a flow field for circulating a fluid to maintain a particular operating temperature or operating temperature range for one or more battery cells. The heat exchanger can be one of a plurality of heat exchangers, for example, where each heat exchanger can be in thermal contact with a battery cell in a battery cell assembly. Where the battery assembly includes a stack of battery cells, heat exchangers can be interleaved with the battery cells.

The battery assembly can be configured to supply high voltage direct current (DC) power to an inverter, which can include a three-phase circuit coupled to a motor to convert the DC power to alternating current (AC) power. In this regard, the inverter can include a switch network having an input coupled to the battery assembly and an output coupled to the motor. The switch network can include various series switches (e.g., insulated gate bipolar transistors (IGBTs) within integrated circuits formed on semiconductor substrates) with antiparallel diodes (i.e., antiparallel to each switch) corresponding to each of the phases of the motor. The battery assembly can include voltage adaption or transformation, such as DC/DC converters. One or more battery assemblies may be distributed within a vehicle where each battery assembly can be made up of a number of battery cells. The battery cells can be connected in series or parallel to collectively provide voltage to the inverter.

The battery assembly can be cooled by a fluid that flows through a coolant loop including one or more heat exchangers. The fluid flows into one or more inlets of the heat exchangers in thermal contact with the battery assembly to exchange heat with the battery cells. The fluid then flows through one or more outlets of the heat exchangers. The fluid can then be recirculated through the coolant loop. For example, a pump can facilitate the movement of the fluid through the coolant loop. The fluid can be generally referred to as a “coolant,” although it should be noted that the coolant may heat or cool various components within the vehicle, including the battery assembly. The coolant can include any liquid that absorbs or transfers heat to cool or heat an associated component, such as water and/or ethylene glycol (i.e., “antifreeze”).

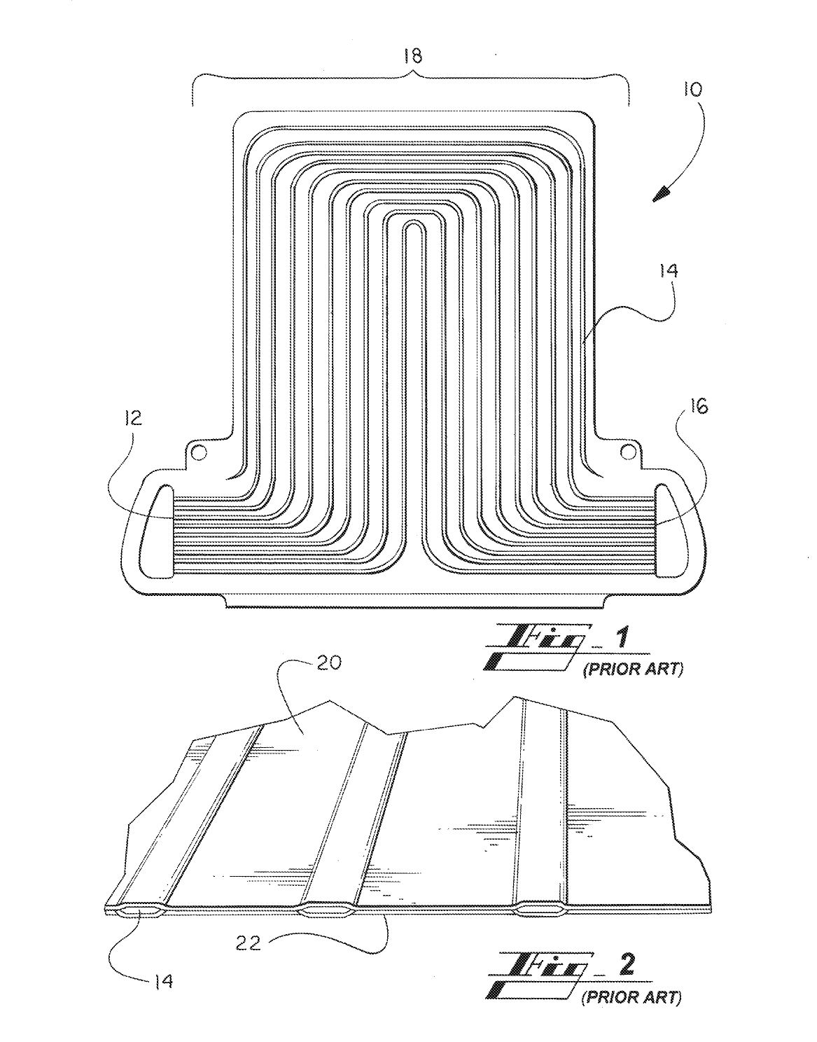

FIG. 1 illustrates a prior art heat exchanger 10 having inlets 12 and outlets 16 and fluid flow channels 14 therebetween forming a flow field 18.

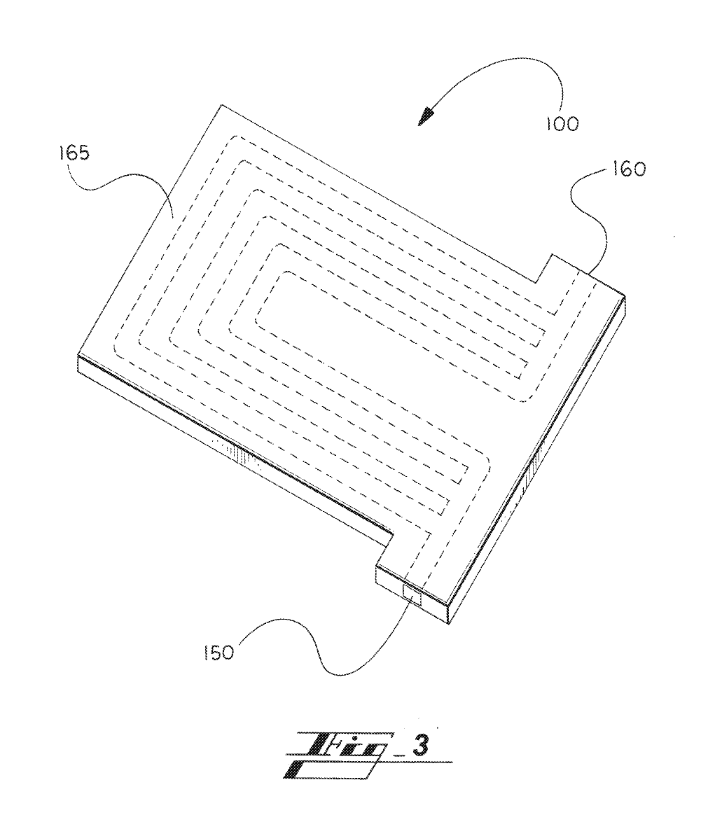

As shown in FIG. 2, this prior art heat exchanger may be formed by two aluminum sheets formed into half plates 20, 22 and brazed together to form a full plate. The plates are laminated with a polymer such as PET to obtain electrical insulation.

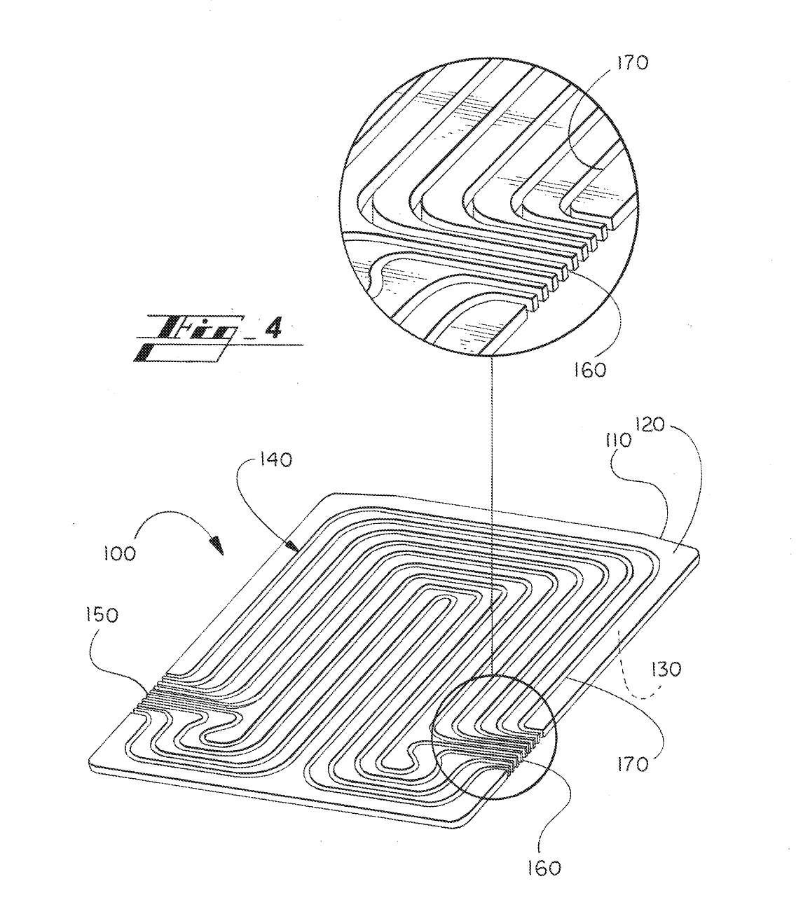

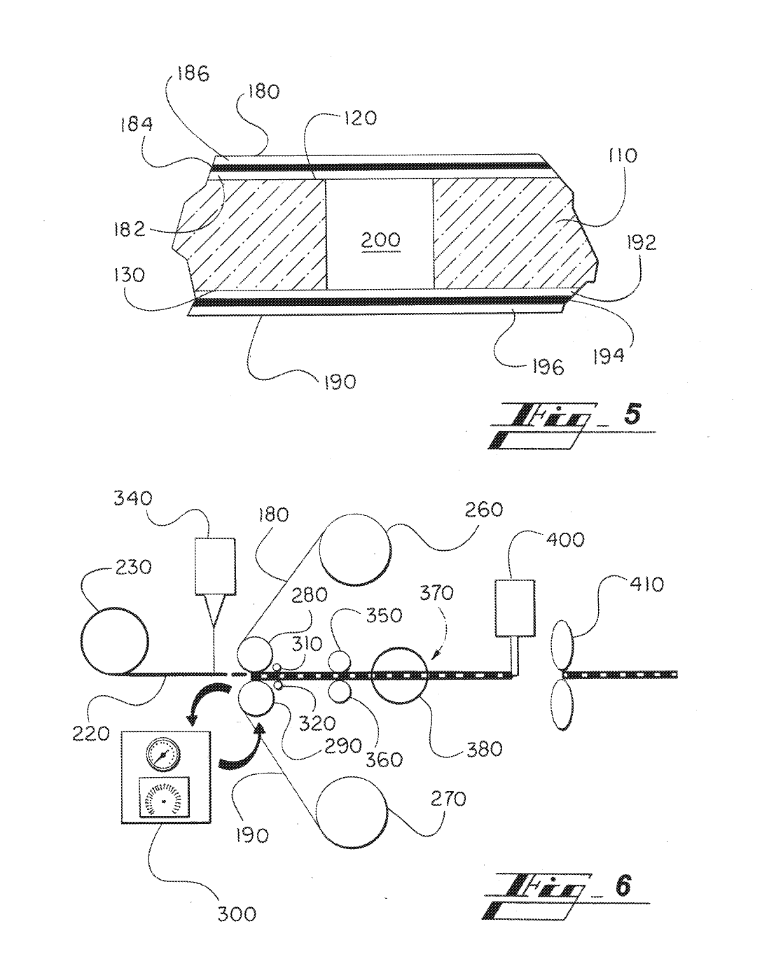

FIGS. 3, 4, and 5 illustrate aspects of the heat exchanger according to an embodiment of the present technology. FIG. 3 shows the heat exchanger external surface. FIG. 4 shows the polymer core plate and FIG. 5 illustrates a cross section of the heat exchanger. Exterior surface 165

In FIG. 3, the heat exchanger 100 is shown having a single inlet 150 and a single outlet 160. Flow fields are shown in dotted lines having a certain path but these fluid flow paths as well as the number and placement of the inlet and outlet are arbitrary.

As shown in FIG. 4, substantially planar core plate 110 has a first surface 120, a second surface 130, and a cutout 140. The cutout 140 includes at least one inlet 150, at least one outlet 160, and a flow field 170 between the inlet 150 and the outlet 160.

FIG. 5 is a cross section of the heat exchanger, showing the core plate 110, a first skin 180 coupled to the first surface 120 of the core plate 110 and a second skin 190 coupled to the second surface 130 of the core plate 110.

The flow field 170, the first skin 180, and the second skin 190 cooperate to form at least one conduit or channel 200 fluidly coupling the inlet 150 and the outlet 160. A plurality of conduits 200 can be defined by the flow field 170, the first skin 180, and the second skin 190, where the conduits 200 fluidly couple the inlet 150 and the outlet 160. The coupling between the first film 180 and the first surface 120 and the coupling between the second film 190 and the second surface 130 can each be substantially fluid-tight, where the resulting conduit 200 is effectively sealed to prevent leakage of coolant between the respective skins 180, 190 and the plate 110.

In the configuration shown in FIGS. 3, 4, and 5, a coolant can flow from the inlet 150 to the outlet 160 through the conduit 200. For example, a cooling system including the heat exchanger 100 can use a pump to circulate the coolant (not shown). The conduit 200 follows the flow field 170 portion of the cutout 140. The conduit 200 can include one or more branch points (not shown) based on the cutout 140 that form multiple conduits 200 between the inlet 150 and the outlet 160. Each of the conduits 200 can further include various intermediate branch points that split into further conduits and/or can include various intermediate coalescing points where multiple conduits coalesce into a fewer number of conduits (not shown). The inlet 150 and the outlet 160 are shown located on opposing lower edges of the heat exchanger 100 in FIG. 4. However, in other embodiments, the inlet 150 and the outlet 160 can be located at various locations within the heat exchanger 100.

In general, the flow field 170 portion of the cutout 140 can be configured to form one or more various pathway shapes and numbers of pathways that cooperate with the first film 180 and the second film 190 to form the conduits 200 of various lengths, dimensions, and branching/coalescing points between the inlet 150 and the outlet 160. In this way, heat exchange of the heat exchanger 100 can be symmetric, asymmetric, optimized for a particular region of the heat exchanger 100, or configured to be substantially uniform across the heat exchanger 100. Typically, the conduit 200 or the plurality of conduits 200 follow a tortuous path between the inlet 150 and the outlet 160, such as a serpentine path, where the path(s) cover a portion of a surface area of the heat exchanger 100.

In an alternative embodiment, the heat exchanger may simply be a “pillow”—having no fluid channels but instead a large fluid reservoir. Other designs are also possible.

The substantially planar core plate 110 is formed of an electrically insulating material that is desirably water and coolant impermeable. It should also be inert to other commonly used coolant additives. It should be nonflammable. In addition it is desirable that the core plate 110 be made of a material that is inexpensive and available in rolls.

Materials that satisfy the aforementioned requirements include various polymers such as, in particular, polyolefins and polyaromatics. Preferred examples include polypropylenes, polyethylenes, and polystyrenes.

The core plate 110 can be formed of one or more polymeric materials, including composites and laminated materials of the above mentioned exemplary materials. In other embodiments, the core plate 110 is formed of a homogeneous polymeric material that consists of one of the aforementioned polymeric materials.

The core plate 110 can have a composite structure and include materials such as carbon flakes or other materials that boost the material's thermal conductivity while leaving it electrically insulating.

Desirably the core plate 110 has a thickness ranging from about 0.2 to 1.0 mm. It should be stable in an operating range of about −40° C. to 85° C. The material should have a flexure strength of about 80 MPa, a compression strength of about 50 MPa, and possess a flexural modulus of about 5 GPa. All values provided have a variance of up to at least 10%.

As shown in FIG. 5, the first skin 180 and the second skin 190 have a trilayer structure. Skins 180 and 190 can have the same structure and composition, or can be different. In one embodiment, shown in FIG. 5, an inner layer 182, 192 (corresponding to skin 180, 190 respectively) is made of a material that will thermally or ultrasonically bond to core plate 110 surface 120, 130, without the need for application of a bonding material such as an adhesive. For example, if 120 is polyethylene, then 182 may be polyethylene. The inner layer and the core can be different materials so long as the adhesion temperature of the inner layer is below the softening point of the core polymer.

A middle layer 184, 194 is aluminum or another material that provides in-plane thermal conductivity. Outer layer 186, 196 is a material that provides electrical insulation from the battery cells, such as polyethylene terephthalate (PET) at a thickness that is appropriate to ensure electrical isolation.

The thickness of skins 180, 190 and of each layer of the composite range from about 50 to 100 μm.

As mentioned, the inner layer 182, 192 of the composite skins is desirably thermally or ultrasonically bonded to the core material 110 surface 120, 130. It is desirable that the composite skins form an adhesive free bond with the core material. This is achievable with thermal bonding or ultrasonic bonding, for example. A polyethylene to polyethylene bond can be achieved at a temperature of about 160° C. to 175° C., and polypropylene can be bonded to polypropylene at a temperature of about 230° C. to 250° C. using a pressure of about 0.25 to 0.50 MPa for about 1 second. Methods of making the heat exchanger are detailed below.

In some embodiments, the first skin 180 and the second skin 190 can be a resilient or elastomeric material that is capable of substantially returning to its original shape after being stretched or compressed. For example, pressure of a coolant moving through the conduit 200 and/or changes in dimensions of an adjacent battery cell during charging and discharging can impose various forces on the skins 180, 190.

The present technology further includes various methods of making a heat exchanger 100, and one embodiment of a method of making a heat exchanger 100 is shown in FIG. 6. The method includes applying the first skin 180 to the first surface 120 of the core plate 110 and the second skin 190 to the second surface 130 in a closed loop laminator.

Using an inline laser or other cutting means, channels 140 are cut in the core plate 110. The skins 180, 190 are preferably simultaneously laminated onto the core plate 110 inside a closed loop laminator. Care is taken to laminate one or both skins onto the core plate 110 as cutting of the plate occurs, to prevent the cut apart pieces of the core plate from becoming disjoined. The core plate 110 is progressively cut and laminated to prevent generating any disjoined parts. An option is to laminate one of the skins 180, 190 followed by the other skin but preferably the skins are laminated simultaneously to avoid geometric distortion.

In the embodiment shown in FIG. 6, a blank 220 is provided as a continuous sheet from a roll 230. Likewise, the first skin 180 and the second skin 190 are provided as continuous sheets from rolls 260, 270 and laminated to the blank 220 with the assistance of rollers 280, 290 and annealing rollers 310, 320. The laminations are conducted within a closed loop laminator 300 via thermal lamination, for example.

The conditions of the closed loop laminator 300 depend upon the properties of the first skin 180 and second skin 190 and the core plate 110. Rollers 280, 290 are hot rollers at a temperature of about 232° C. to 260° C. for a polypropylene core and skin inner layer, and 176° C. to 204° C. for a low density polyethylene core and skin inner layer. Annealing rollers 310, 320, or a multiplicity thereof, are used to apply a pressure of 275 to 345 MPa and a temperature that allows a controlled cooling process.

Additional rollers 350, 360 further along the process apply temperature and pressure to the laminated heat exchanger. They are at a lower temperature than the hot rollers 280, 290 and allow for the cooling of the fin so the product will be free of deformations or warping.

To seal the sides of the heat exchanger 110 and prevent exposure of the edges of the skins 180, 190 (particularly of the aluminum layers 184, 194), the laminated sheet is passed through longitudinal double-hem devices 370 and 380 (not clearly shown). The longitudinal double hemming process is performed on each side of the fin feed stock simultaneously and continuously to form a fluid tight seal that is free of exposed metal within the laminate.

A cutter 400 cuts the formed heat exchanger to the designed size.

In a further step, the formed and cut heat exchanger is subjected to a transverse double-hem machine 410, which seals the cut transverse edges.

In one aspect of the present technology, the surfaces of the core plate 110 are textured. This allows the internal layers 182, 192 of the skins 180, 190 to adhere better to the core plate 110. Useful textures include matte, pebbled, honed, and functionally grained finishes to increase the contact surface area between the core and the skin and to provide egress for trapped air during the joining process thereby improving adhesion.

The present technology also includes methods to thermally manage a battery cell. In one such embodiment, the heat exchanger 100 is placed in thermal contact with the battery cell, wherein the heat exchanger 100 includes the features described herein. A fluid is circulated through the at least one conduit 200 of the heat exchanger 100. In this manner, the battery cell can be maintained at a particular operating temperature or temperature range.

Various benefits and advantages are afforded by the present technology. The use of adhesive is avoided, keeping the cost of materials and of the method down. Commercially available materials are used for the core plate and the films. The use of a clean room for manufacture is avoided. In addition, brazing is avoided. The use of polymeric materials also provides a cost savings versus metals. The roll-to-roll method enables manufacture of heat exchangers of varying lengths.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A heat exchanger having at least one inlet, at least one outlet, and at least one conduit between the inlet and the outlet, the heat exchanger comprising:
a substantially planar core plate having a first surface, a second surface, and a cutout;
a first skin bonded to the first surface; and
a second skin bonded to the second surface;
wherein the first skin, the second skin, and the cutout cooperate to form the at least one conduit fluidly coupling the inlet and the outlet; and
wherein at least one of the first skin and the second skin has a trilayer structure and is nonadhesively bonded to the first or second surface.

2. The heat exchanger of claim 1, wherein the trilayer skin comprises an electrically insulating outer layer, a middle layer that provides in-plane thermal conductivity, and an inner layer that will thermally bond to the core plate first or second surface.

3. The heat exchanger of claim 2, wherein the inner layer has an adhesion temperature below the softening temperature of the core plate.

4. The heat exchanger of claim 1, wherein the core plate comprises an electrically insulating polymer that is water and coolant impermeable selected from polyolefins and polyaromatics.

5. The heat exchanger of claim 4, wherein the core plate is polyethylene or polypropylene.

6. The heat exchanger of claim 4, wherein the core plate is a polymer composite containing carbon flakes.

7. The heat exchanger of claim 2, wherein the inner layer of the skin is the same material as the core plate.

8. The heat exchanger of claim 2, wherein the middle layer of the skin is aluminum.

9. The heat exchanger of claim 2, wherein the outer layer is polyethylene terephthalate.

10. The heat exchanger of claim 1, wherein at least one of the first surface or the second surface of the core plate is textured.

11. A roll to roll method of making a heat exchanger comprising:
providing a first roll of a core plate material that has a first side and a second side;
providing a second roll of a first skin material and a third roll of a second skin material;
cutting a cutout in the core plate material wherein the cutout includes an inlet, an outlet, and a flow field between the inlet and the outlet;
bonding the first skin material to the first side of the core plate material and the second skin material to the second side of the core plate material; and
cutting the laminated core plate and skins to the desired size.

12. The method of claim 11, wherein the bonding is accomplished nonadhesively.

13. The method of claim 12, wherein the bonding is thermal.

14. The method of claim 11, wherein the bonding is accomplished as soon as possible after cutting so that the integrity of the cutout is maintained.

15. The method claim 11, wherein the bonding is conducted in a closed cell laminator under controlled pressure, temperature, feed rate, and other variables important to the lamination process.

16. The method of claim 12, wherein at least one of the first or second skin is a trilayer with an electrically insulating outer layer, a middle layer that provides in-plane thermal conductivity, and an inner layer that will thermally bond to the core plate first or second surface.

17. The method of claim 16, wherein the middle layer is aluminum.

18. The method of claim 16, further comprising using a double hemming method to seal the edges of the bonded core plate, first skin, and second skin.

19. The method of claim 18, further comprising using a transverse double hemming method to seal the transverse edges of the bonded core plate, first skin, and second skin.

20. A method of cooling a battery cell comprising placing at least one heat exchanger of claim 1 in thermal contact with the battery cell and circulating a cooling fluid through the heat exchanger.
